(19) United States
(12) Patent Application Publication
(10) Pub. No.: US 2007/0186433 A1
(43) Pub. Date: Aug. 16, 2007

(54) Ratchet lock for automatic tape measure

(76) Inventor: David C. Campbell, Bel Air, MD (US)

Correspondence Address: SHOOK, HARDY & BACON LLP;INTELLECTUAL PROPERTY DEPARTMENT, 2555 GRAND BLVD, KANSAS CITY, MO, 64108-2613, US

(21) Appl. No.: 11/325,122

(22) Filed: Jan. 4, 2006

(51) Int. Cl. G01B 3/10

(52) U.S. Cl. 33/767

(57) ABSTRACT

An automatic tape measure having a tape retraction prevention device to prevent unintended retraction of the tape into a housing caused by increasing the strength of a return spring. A tape assembly is received in the housing and includes a tape selectively received on a reel, the return spring and a cassette for receiving the reel. A motor is coupled with a power source, a drive assembly, the tape assembly and a switch assembly to control extension and retraction of the tape. The drive assembly couples the motor with the tape assembly and includes at least one gear. The tape retraction prevention device includes a pawl that may engage with the gear to prevent rotation of the drive assembly and, in turn, unintended retraction of the tape into the housing.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates generally to a tape measure and, more particularly, to an automatic tape measure that utilizes a retraction prevention mechanism with the drive assembly for maintaining extension of the tape.

Automatic tape measures are generally used to measure an existing object or as a tool for marking and measuring distances. The tape is automatically extended from the front wall of the housing using a motor, a drive assembly, and a reel. The reel is typically rotatably coupled to and positioned within the housing. The tape is wound on the reel which includes a recoil spring that assists in retracting the tape. The motor rotates the drive assembly which extends the tape out of the housing. The drive assembly includes a combination of gears and rollers that are coupled with the motor and engaged with the tape. The motor may then activate the drive assembly which, in turn, extends the tape out of the housing a desired amount. However, in the standard embodiment, the motor only assists with extension of the tape, not retraction. As stated above, the recoil spring assists the reel in rewinding the tape.

When the tape has been extended a desired amount, the drive assembly remains engaged with the tape. The resistance of the motor to being rotated backwards prevents the spring from recoiling the tape. Thus, in order for retraction to occur, the drive assembly must be disengaged from the tape to allow the recoil spring to retract the tape and the motor is deactivated. One design issue, however, with the recoil spring is the difficulty of the recoil spring to retract the tape when it has been extended a great distance. A solution to this problem is to increase the tension of the recoil spring such that it more readily provides for tape retraction when the drive assembly is disengaged from the tape. However, when the tension of the spring is increased to provide for greater retraction power, the rewind force of the recoil spring often overcomes the braking force naturally provided by the non-activated motor and, thus, will retract the tape when the motor is deactivated even though the drive assembly is still engaged with the tape. When the braking force of the motor is overcome, a “creeping” of the tape back into the housing occurs from the extended position. This is due to the large recoil force of the recoil spring tending to urge the retraction of the tape via the reel by overcoming the natural braking force of the motor.

Thus, it would be desirable to manufacture an automatic tape measure with a drive mechanism that utilizes a recoil spring for retraction, but which also provides a retraction prevention mechanism that prohibits the recoil spring of the drive mechanism from automatically retracting the tape by overcoming the braking force provided by the motor.

### BRIEF SUMMARY OF THE INVENTION

This invention is directed to an automatic tape measure with a retraction prevention mechanism. The tape measure contains a housing, a tape assembly, a motor, a drive assembly, and a retraction prevention mechanism. The housing is a container configured to hold the tape assembly, the motor, and the drive assembly. The tape assembly preferably includes a tape, a reel, and a cartridge or cassette. A switch assembly is used in conjunction with the drive assembly and reel to extend and retract the tape. Extension of the tape is provided via an extension button and retraction of the tape is provided via a retraction button, both of the switch assembly.

The drive assembly includes a motor, a drive gear, a ratchet gear, a ratchet wheel, and a drive wheel. The drive assembly is positioned within the housing such that the drive wheel contacts the tape to extend it from the housing. It is understood that pressing the extension button causes an output from the motor, through a combination of gears and rollers, to extend the tape from within the housing. Pressing the retraction button causes retraction of the tape within the housing by disengaging the drive assembly from the tape. Once disengaged, a recoil spring coupled to the reel causes the tape to retract within the housing. The recoil spring provides a rewind force on the reel to cause retraction.

The tape measure also includes a retraction prevention device. In one embodiment, the retraction prevention device includes a ratchet pawl. The ratchet pawl is pivotably mounted to a lower portion of an inner housing. The ratchet pawl is biased into contact with the ratchet gear by a torsion spring. The ratchet pawl permits rotation of the ratchet gear in a first direction of rotation when the tape is being extended from the housing. However, when the ratchet gear attempts to rotate in a second direction, the ratchet pawl engages the ratchet gear. Thus, the ratchet pawl prohibits the retraction of the tape within the housing due to the recoil spring overcoming the braking force of the motor. Retraction of the tape may then only occur by pressing the retraction button to disengage the ratchet pawl from the ratchet gear, as well as the drive assembly from the tape.

In another embodiment, the retraction prevention mechanism includes a ratchet pawl and a disc with a pair of depending ears. The ratchet pawl of this embodiment is not biased into contact with the ratchet gear by a spring, but is instead biased to a disengaged position. When the motor is inactive and the rewind force of the recoil spring overcomes the braking force of the motor, the tape will initially begin to retract within the housing. However, during this initial retraction, the ears of the disc will contact the ratchet pawl and move it into contact with the ratchet gear. At this point the ratchet pawl is engaged with the ratchet gear and, thus, unintentional retraction of the tape is prevented. Retraction of the tape may then only occur by pressing the retraction button to disengage the drive assembly from the tape.

### BRIEF DESCRIPTION OF THE SEVERAL VIEWS OF THE DRAWING

These and other objectives and advantages of the present invention will be more readily apparent from the following detailed description of the drawings of the preferred embodiment of the invention that are herein incorporated by reference and in which:

FIG. 1 is a cross-sectional side-elevation view of a tape measure of the present invention with a portion of the cassette cut away;

FIG. 2 is an enlarged, fragmentary side-elevation view of the tape measure of FIG. 1 with portions thereof cut away to show more detail of the various internal components and a drive mechanism engaged with the tape;

FIG. 3 is a side-elevation view of the tape measure of FIG. 2 with the drive mechanism disengaged from the tape;

FIG. 4 is a cross-sectional side-elevation view of an alternate embodiment of a tape measure of the present invention with a portion of the cassette cut away and illustrating a ratchet pawl disengaged from a ratchet gear; and

FIG. 5 is a cross-sectional, fragmentary, perspective view of the tape measure of FIG. 4 with the ratchet pawl engaged with the ratchet gear by an ear of a disc.

### DETAILED DESCRIPTION OF THE INVENTION

With initial reference to FIG. 1, an automatic tape measure according to the principles of the present invention is designated generally with the reference numeral 10. The tape measure 10 includes a housing 12, a tape assembly 14, a drive assembly 16, and a retraction prevention mechanism 18. The housing 12 includes a pair of opposed sidewalls 20, 22, top and bottom walls 24, 26, and front and rear walls 28, 30. It should be understood that the sidewall 20 is not shown as that portion of the housing 12 has been removed from the Figures to permit viewing of the interior of the housing 12. The housing 12 is preferably two halves that mate in clamshell fashion, and is constructed from molded plastic, however, any suitable material may be used. The housing 12 is configured to define a container that houses the tape assembly 14, the drive assembly 16, and the retraction prevention mechanism 18.

The tape assembly 14 includes a tape 32, a reel 34, a recoil spring 36 (not shown), a cartridge 38, and a switch assembly 40. The tape 32 is wound on the reel 34 such that a bottom surface 42 of the tape faces outwardly, as is understood by one of ordinary skill in the art. The cartridge 38 is a two-piece shell that houses the tape 32, the reel 34 and the recoil spring 36. The recoil spring is coupled on one end with the reel 34 and on another end with the cartridge 38, such that rotation of the reel 34 with respect to the cartridge causes a change in the tension of the recoil spring 36. The cartridge 38 contains a pair of depending tabs 44 that permit attaching it to the sidewall 22 of the housing 12.

The extension of the tape 32 from the housing 12 is controlled by the switch assembly 40 and the drive assembly 16, as will be further discussed below. Both the switch assembly 40 and the drive assembly 16 are electrically coupled to a power source 46, as is understood by one of ordinary skill in the art. During extension, the tape 32 is guided by a roller 48 located adjacent the bottom wall 26 and near the front wall 28. The tape 32 includes a hook 50 and extends through an opening 51 in the front wall 28, as is understood by one of ordinary skill in the art.

The switch assembly 40 is preferably located in the top wall 24 of the housing 12 and includes extension and retraction buttons 52, 54. It will be appreciated by one of ordinary skill in the art that the buttons 52, 54 of the tape assembly 14 allow for forward movement and rearward retraction of the tape 32 via the drive assembly 16 and the recoil spring 36, respectively. The recoil spring 54, when permitted, retracts the tape 32 into the housing 12.

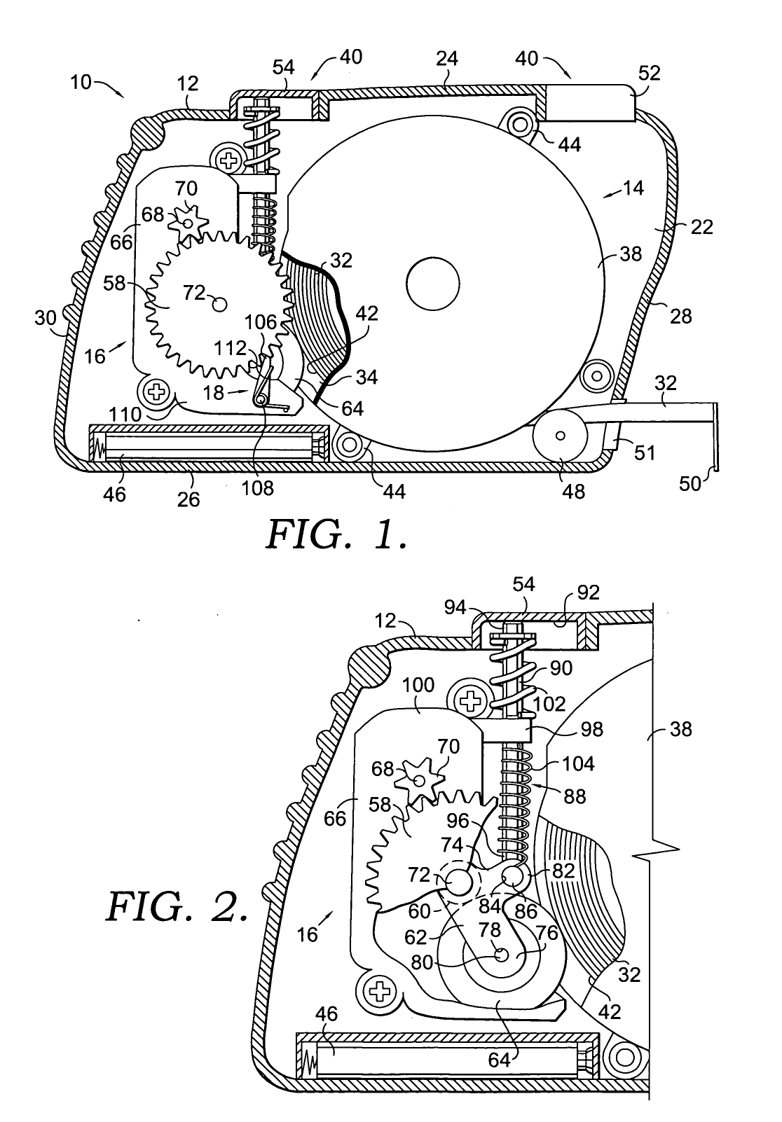

Referring now to FIGS. 1 and 2, the drive assembly 16 will be discussed. The drive assembly 16 is positioned within the housing 12 to contact the bottom surface 42 of the tape 32 as it is on the reel to extend the tape 32 from the housing 12. The drive assembly 16 includes a motor 56 (not shown), a ratchet gear 58, a ratchet wheel 60, a pair of swingarms 62, and a drive wheel 64. The motor 56 is located in an inner housing 66, the inner housing 66 being attached to the tape housing 12. The motor 56 includes an output axle 68 with a drive gear 70 attached thereto. The motor 56 is powered by the power source 46, as is understood by one of ordinary skill in the art.

The drive gear 70 is in engagement with the ratchet gear 58. The ratchet gear 58 is located on a transmission axle 72, the axle 72 being rotatably mounted with the inner housing 66. As the motor 56 turns, the drive gear 70 transfers torque from the output axle 68 to the ratchet gear 58. As best seen in FIG. 2, the ratchet wheel 60 is also coupled to the transmission axle 72. Thus, as the ratchet gear 58 turns so does the ratchet wheel 60. The ratchet wheel 60 is adjacent to and configured to frictionally engage the drive wheel 64, as will be further discussed below.

The swingarms 62 are generally kidney shaped, as illustrated, and are rotatably coupled to the transmission axle 72. It should be understood that a swingarm 62 is located on each side of the ratchet wheel 60 and the drive wheel 64. The swingarms 62 have an upper portion 74 and a lower portion 76. The lower portion 76 depends downwardly from the axle 72 and has an aperture 78. The apertures 78 on each swingarm 62 align to receive a wheel axle 80 to mount the drive wheel 64 thereon. The upper portion 74 contains an arm 82 with an aperture 84. The apertures 84 on each arm 82 align to receive a pin 86, the importance of which will be further described below.

Continuing with the discussion of the drive assembly 16, the drive wheel 64 will now be discussed. As stated above, the drive wheel 64 is mounted on the wheel axle 80 received between the swingarms 62. As best seen in FIG. 2, the drive wheel 64 is frictionally engaged with the ratchet wheel 60. During extension and rest, the drive wheel is also frictionally engaged with the bottom surface 42 of the tape 32. Thus, rotation of the ratchet wheel 60 causes rotation of the drive wheel 64 which, in turn, contacts the bottom surface 42 of the tape 32 and causes it to extend from the housing 12.

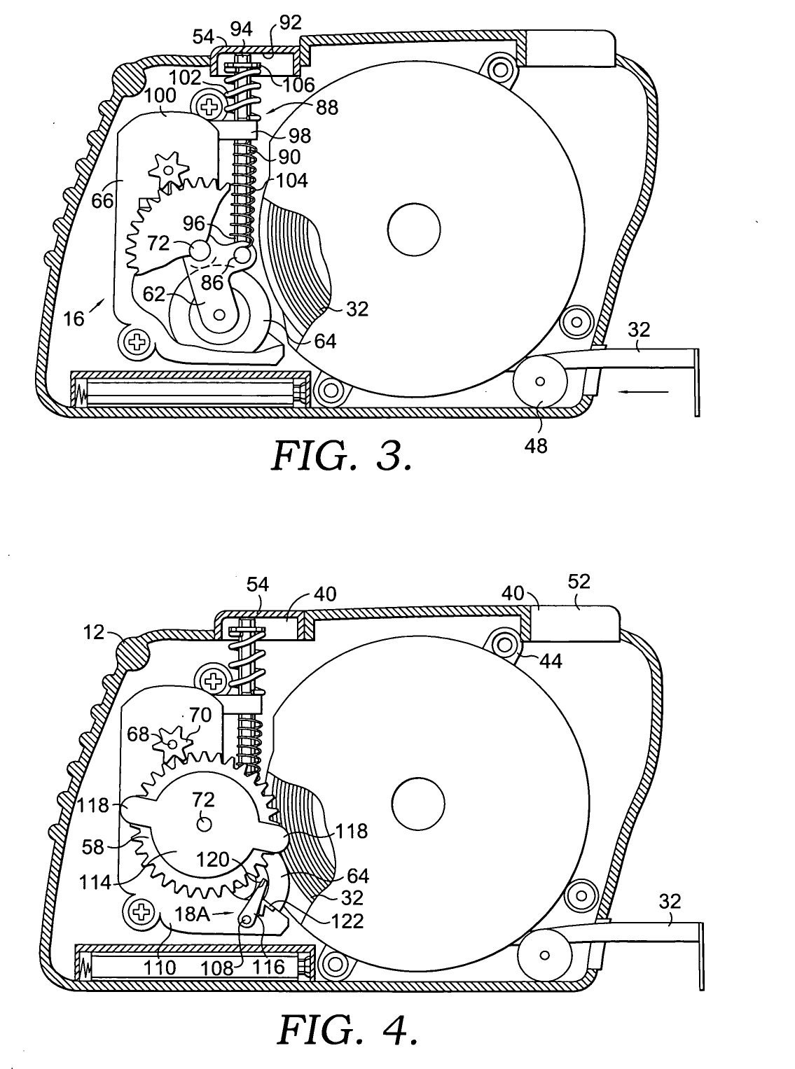

The drive assembly 16 further includes an adjustment mechanism 88, as shown in FIGS. 2 and 3. The adjustment mechanism 88 includes a generally vertical rod member 90. The member 90 abuts an underside 92 of the retraction button 54 at an upper end 94 and abuts the pin 86 of the drive mechanism 16 at a lower end 96, as will be further discussed below. The member 90 is guided by a pilot flange 98 extending horizontally from an upper portion 100 of the inner housing 66.

The adjustment mechanism 88 also contains a compression spring 102 and a tension spring 104. The compression spring 102 surrounds the member 90 and is located between the pilot flange 98 and a flange 106 located proximate the upper end 94 of the member 90. The compression spring 102 biases the member 90 and, thus, the retraction button 54 upwardly. The tension spring 104 extends between the pilot flange 98 and the drive mechanism 16. An upper end of the tension spring 104 is coupled to the pilot flange 98 while a lower end of the tension spring 104 is coupled to the pin 86. The tension spring 104 biases the swingarm 62 and, thus, the drive wheel 64 upwardly to maintain contact between the drive wheel 64 and the bottom surface 40 of the tape 32, as will be further discussed below.

Referring again to FIG. 1, the retraction prevention mechanism 18 will be discussed. The retraction prevention mechanism 18 includes a ratchet pawl 106. The ratchet pawl 106 is pivotably coupled to a protrusion 108 located on a lower portion 110 of the inner housing 66. The ratchet pawl 106 extends upwardly and engages the ratchet gear 58. The ratchet pawl 106 is biased into contact with the ratchet gear 58 by a torsion spring 112. As explained in greater detail below, the ratchet pawl 106 prohibits “creeping” of the tape 32 back into the housing 12 from its extended position by limiting the clockwise rotation of the ratchet gear 58.

Referring now to FIGS. 1 and 2, the operation of the tape measure 10 will be discussed. The tape is extended by depression of the extension button 52. Depression of the extension button 52 activates the motor 56 and causes the output axle 68 to rotate in a clockwise direction, as is understood by one of ordinary skill in the art. The clockwise rotation of the output axle 68 causes clockwise rotation of the drive gear 70. The clockwise rotation of the drive gear 70 causes counter-clockwise rotation of the ratchet gear 58 and, in turn, the transmission axle 72. The counter-clockwise rotation of the transmission axle 72 rotates the ratchet wheel 60, which is frictionally engaged with the drive wheel 64, as seen in FIG. 2. The counter-clockwise rotation of the ratchet wheel 60 causes clockwise rotation of the drive wheel 64, which, in turn, extends the tape 32 from the housing 12.

As stated above, the ratchet pawl 106 is biased into contact with the ratchet gear 58 by the torsion spring 112. Thus, as the ratchet gear 58 rotates in the counter-clockwise direction, the ratchet pawl 106 slides along and abuts the outer periphery of the ratchet gear 58. However, should the ratchet gear 58 start to rotate in a clockwise direction, which can happen when the tape 32 is extended and the motor 56 is inactive, if the rewind force of the recoil spring 36 is sufficient to overcome the braking force of the motor 56, the distal end of the ratchet pawl 106 will become engaged in the teeth of the ratchet gear 58, as illustrated in FIG. 1, and prevent further clockwise rotation of the ratchet gear 58. As such, the ratchet pawl 106 exists to prevent the “creeping” of the tape 32 back into the housing 12 by engaging the ratchet wheel 58 to prevent backward rotation of the drive assembly 16.

Intended retraction of the tape 32 will be discussed with reference to FIGS. 2 and 3. FIG. 2 shows the drive wheel 64 engaged with the bottom surface 42 of the tape 32 for extension or holding of the tape 32. FIG. 3 shows the drive wheel 64 disengaged from the bottom surface 40 of the tape 32 to permit retraction of the tape 32 within the housing 12. In order to retract the tape 32 within the housing 12, the retraction button 54 is depressed. Depression of the retraction button 54 causes the button to contact the upper portion 94 of the member 90 and move the member 90 downwardly. This downward movement of the member 90 causes the lower portion 96 of the member 90 to contact the pin 86. As shown in FIG. 3, contact with the pin 86 causes the swingarms 62 to rotate about the transmission axle 72. This rotation causes the drive wheel 64 to disengage from the bottom surface 42 of the tape 32 and, thus, the tape 32 is allowed to freely retract within the housing 12 via the recoil spring 36. To stop retraction, the user simply removes the downward pressure from the retraction button 54. As shown in FIG. 3, once the downward pressure is removed, the compression spring 102 returns the retraction button 52 to its original rest position and the tension spring 104 rotates the drive wheel 64 back into contact with bottom surface 40 of the tape 32.

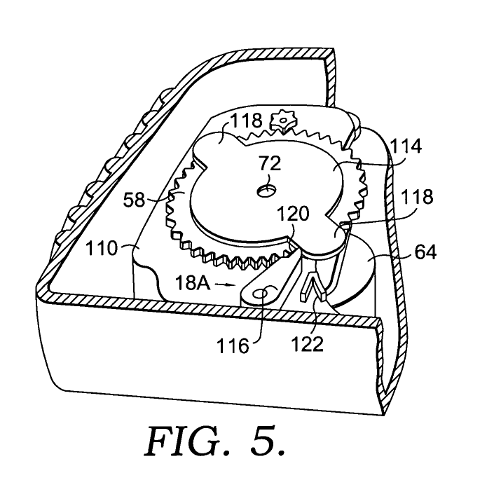

In another aspect, an alternate embodiment of the retraction prevention mechanism 18A will be discussed. Referring now to FIGS. 4 and 5, the retraction prevention mechanism 18A includes a disc 114 and a ratchet pawl 116. The disc 114 is coupled to the ratchet wheel 58 via the transmission axle 72. The disc 114 includes a pair of ears 118 depending therefrom and oriented in opposed relation to one another. The ratchet pawl 116 is pivotably coupled to the protrusion 108. The ratchet pawl 116 includes a taper 120 at its upper end. The movement of the ratchet pawl 116 away from the ratchet gear 58 is limited by a stop 122. The stop is a V-shaped protrusion that depends from the lower portion 110 of the inner housing 66.

Referring now to FIGS. 4 and 5, the operation of the tape measure 10, specifically the extension and retraction of the tape 32, for the alternate embodiment is the same as the previous embodiment discussed above. The only difference is the manner in which the retraction prevention mechanism 18A operates. In this embodiment, the ratchet pawl 116 is not biased into engagement with the ratchet gear 58 as was the pawl 106 of the first embodiment. Instead, the pawl 116 is frictionally mounted to resist rotation by an external force (e.g., the ears 118 or the teeth of the ratchet gear 58). Once the force is removed, the pawl will remain in its present location until moved again by an external force. In this embodiment, should the rewind force of the recoil spring 54, not shown, overcome the braking force of the motor 56, the clockwise rotation of the ratchet gear 58 and in turn the disc 114, would cause one of the ears 118 to contact the ratchet pawl 116 and move it into contact with the ratchet gear 58, thus, preventing further backward movement of the drive assembly 16 and, in turn, unintended retraction of the tape 32. It should be understood while the ears 118 move the ratchet pawl 116 into blocking engagement with the ratchet gear 58 during retraction, the ears 118 also move the ratchet pawl 116 out of blocking engagement with the ratchet gear 58 during extension and the taper 120 on the ratchet pawl 116 allows the ears 118 to ultimately pass by the ratchet pawl 116 during extension.

The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages, which are obvious and inherent to the system and method. It will be understood that certain features and subcombinations are of utility and may be employed without reference to other features and subcombinations. This is contemplated and within the scope of the claims.

What is claimed is:

1. A tape measure comprising:
a housing;
a tape assembly received in the housing, the tape assembly having a tape, a reel and a return spring, the tape being wound upon the reel and the reel being mounted within the housing, wherein the tape is adapted to extend from and retract into the housing, wherein the return spring is coupled with the reel to assist with retraction of the tape;
a first gear coupled with the reel, whereby rotation of the reel causes rotation of the gear; and
a pawl adjacent the first gear, the pawl being movable between an engaged position and a disengaged position, wherein the pawl prevents rotation of the gear in a first direction when the pawl is in the engaged position.

2. The tape measure of claim 1, wherein the pawl is biased toward the engaged position by a spring.

3. The tape measure of claim 2, further comprising a power source contained within the housing.

4. The tape measure of claim 3 further comprising a motor and a switch assembly coupled to the power source and the motor, wherein the switch assembly controls extension and retraction of the tape.

5. The tape measure of claim 4, further comprising a drive assembly supported in the housing, the drive assembly including:
the motor, wherein the motor is received within the housing and is coupled to the power source, the motor having a rotatable output axle;
a drive gear coupled to the output axle;
a transmission axle rotatably supported in the housing, wherein the first gear is coupled with the transmission axle;
a wheel coupled with the transmission axle; and
an arm rotatably coupled with the transmission axle, the arm having an upper portion and a lower portion, wherein the upper portion is coupled with the switch assembly, and wherein the lower portion contains a drive wheel, the drive wheel being frictionally engaged with the wheel and the tape.

6. The tape measure of claim 5, wherein activation of a portion of the switch assembly causes the power source to activate the motor to extend the tape from the housing via the drive assembly.

7. The tape measure of claim 6, wherein activation of a portion of the switch assembly causes the drive wheel to disengage from the tape, thereby permitting the tape to retract into the housing.

8. The tape measure of claim 1, further comprising a disc coupled with the first gear, the disc having at least one depending ear, wherein rotation of the gear in the first direction rotates the disc, which in turn moves the ear into contact with the pawl, which in turn moves the pawl into the engaged position, thereby preventing further rotation of the gear in the first direction.

9. The tape measure of claim 1, wherein pawl is biased into abutting contact with the first gear and wherein the pawl permits rotation of the gear in a second direction when the pawl is in the disengaged position.

10. A tape measure comprising:
a housing;
a tape assembly having a tape selectively received on a reel, the reel being mounted within the housing, wherein the tape is adapted to extend and retract from the housing;
a first gear coupled with the reel whereby rotation of the reel causes rotation of the gear;
a pawl adjacent the first gear, the pawl being movable between an engaged position and a disengaged position, wherein the pawl prevents rotation of the gear in a first direction when in the engaged position; and
a disc coupled with the first gear, the disc having at least one ear extending therefrom, wherein the ear is adapted to move the pawl into the engaged position.

11. The tape measure of claim 10, wherein the disc has a pair of ears, wherein the ears are orientated in an opposed relationship.

12. The tape measure of claim 11, further comprising a power source received in the housing and a switch assembly coupled to the power source, the switch assembly having extension and retraction buttons.

13. The tape measure of claim 12, further comprising a drive assembly supported in the housing, the drive assembly including:
an inner housing;
a motor received within the inner housing and coupled to the power source, the motor having a rotatable output axle;
a drive gear received on the output axle;
a transmission axle rotatably supported by the inner housing and having a portion extending therefrom, the first gear being received on the transmission axle;
a wheel received on the transmission axle; and
an arm rotatably received on the transmission axle, the arm having an upper portion and a lower portion, the upper portion being coupled to the retraction button and the lower portion supporting a drive wheel, the drive wheel being frictionally engaged with the wheel and the tape.

14. The tape measure of claim 13, wherein activation of the extension button causes the power source to activate and the motor to extend the tape via the drive assembly.

15. The tape measure of claim 14, wherein activation of the retraction button rotates the arm thereby causing the drive wheel to disengage from the tape which permits the tape to retract within the housing.

16. A tape measure comprising:
a housing;
a reel rotatably received in the housing;
a return spring coupled with the reel and the housing, the return spring biased to rotate the reel in a first direction;
a tape selectively received on the reel and adapted to extend from and retract into the housing;
a first gear coupled with the reel;
a motor received in the housing, wherein activation of the motor causes rotation of both the first gear and the reel; and
a pawl received in the housing and movable between a first position and a second position, wherein the pawl prevents rotation of the reel in the first direction when the pawl is in the first position, and wherein the pawl permits rotation of the reel in a second direction when the pawl is the second position.

17. The tape measure of claim 16 further comprising a drive wheel, wherein the drive wheel is movable between an engaged position and a disengage position, wherein the drive wheel frictionally engages a portion of the tape received on the reel in the engaged position, wherein rotation of the drive wheel in the engaged position causes rotation of the reel, and wherein movement of the drive wheel to the disengage position permits rotation of the reel in the first direction by the return spring.

18. The tape measure of claim 17 further comprising a cartridge received within and removably coupled to the housing, wherein the reel and the return spring are received within the cartridge, wherein the cartridge has a first opening therein for permitting the tape to extend therethrough, and wherein the cartridge has a second opening for permitting the drive wheel to frictionally engage a portion of the tape received on the reel.

19. The tape measure of claim 16 further comprising a cartridge received within and removably coupled to the housing, wherein the reel and the return spring are received within the cartridge, and wherein the cartridge has a first opening therein for permitting the tape to extend therethrough.
